(19) United States
(12) Patent Application Publication
(10) Pub. No.: US 2018/0274953 A1
(43) Pub. Date: Sep. 27, 2018

(54) OPTICAL SENSOR FOR DETECTING A PARAMETER OF INTEREST

(71) Applicant: SCHLUMBERGER TECHNOLOGY CORPORATION, Sugar Land, TX (US)

(72) Inventor: Daniele Molteni, Cambridge (GB)

(21) Appl. No.: 15/556,258

(22) PCT Filed: Mar. 1, 2016
(86) PCT No.: PCT/US2016/020295

§ 371 Date: Sep. 6, 2017

(30) Foreign Application Priority Data
Mar. 6, 2015 (GB) 1503800.3

(51) Int. Cl. G01D 5/353; G01V 1/52; G02B 6/28

(52) U.S. Cl. CPC G01D 5/35358; E21B 47/00; G02B 6/28; G01V 1/52

(57) ABSTRACT

An optical sensor apparatus (102) comprises a length of optical fibre (302) capable of supporting forward direction propagation and reverse direction propagation. The length of optical fibre is interrupted by a plurality of longitudinally spaced shunt devices (220, 306, 308) disposed along the length of optical fibre (302). A plurality of return optical fibres (222, 318, 324) are respectively coupled to the plurality of shunt devices (220, 306, 308) and each of the shunt devices (220, 306, 308) is propagation direction selective.

### BACKGROUND

Embodiments of the present disclosure relate to an optical sensor apparatus of the type that, for example, comprises a length of optical fibre. Embodiments of the present disclosure relate to a method of detecting a parameter of interest using a fibre optic sensor, the method being of the type that, introduces a probe signal into a length of optical fibre.

Hydrocarbon fluids such as oil and natural gas are obtained from a subterranean geologic formation, referred to as a reservoir, by drilling a well that penetrates the hydrocarbon-bearing formation. Once a wellbore is drilled, various forms of well completion components may be installed in order to control and enhance the efficiency of producing the various fluids from the reservoir. One piece of equipment which may be installed is a sensing system, such as a fibre optic based sensing system to monitor various downhole parameters that provide information that may be useful in controlling and enhancing production. However, wellbore applications are by no means the only applications where fibre optic sensing systems can be employed, for example fibre optic sensing systems find application in marine streamers.

Typically, a fibre optic sensor of the fibre optic sensing system comprises a length of optical fibre that is interrogated by launching pulses of light into the optical fibre. To measure temperature, vibration or strain, distributed fibre optic sensing systems measure, for example, the amplitude of Rayleigh backscatter returned from the fibre optic sensor when excited by the pulses of light. Such sensing systems are useful for tracking the movement of certain events and/or classifying various types of disturbances. However, for some applications, phase-related measurements can be used to determine other parameters.

One known fibre optic sensing system is a Distributed Vibration Sensing (DVS) system, for example a heterodyne DVS (hDVS) system. In such a sensing system, dynamic range is an important system parameter that requires the frequency of the pulses of light injected into the optical fibre, hereafter referred to as the Pulse Repetition Frequency (PRF), to be supportive of the desired system dynamic range. However, as a result of the PRF used, a limitation is imposed on the maximum length of the optical fibre that can be interrogated: as the PRF increases, the maximum length of the optical fibre decreases, because any pulse launched into the optical fibre must not propagate along the optical fibre while backscattered light attributable to a preceding pulse is propagating along the optical fibre. For some applications, this constraint might be disadvantageous. For example, if the optical fibre sensor is adopted in a marine streamer and if the optical fibre is wrapped to form coils, the total available fibre length might be insufficient to support the required streamer length required.

GB Patent no. 2 416 587 relates to an optical time domain reflectometry apparatus that comprises an optical source, a detector, a first section of optical fibre and a second section of optical fibre. The first section of optical fibre comprises a first optical fibre and a second optical fibre, the first optical fibre being connected to the second section of optical fibre, and the second section of optical fibre is deployed in a region of interest. The first optical fibre conveys light towards the second section of optical fibre and the second optical fibre conveys backscattered light returned from the second section of optical fibre to the detector.

GB Patent no. 2 416 588 discloses an optical time domain reflectometry apparatus similar to that disclosed in GB Patent no. 2 416 587, but a remote amplifier is arranged between the first and second sections of optical fibre in order to compensate for attenuation losses in the intensity of the light propagating through the first section of optical fibre. However, the same optical circuit is essentially used to separate a launched optical signal from the backscattered light

However, in the above known systems, a first length of optical fibre is used to convey a probe signal to a location of interest and then a sensing length of optical fibre is used for measurement purposes. As such, the systems described suffer from a need to balance dynamic range with the length of the optical fibre used for measurement purposes. Consequently, since actual measurement is only performed in a second optical fibre, whilst useful for some applications, these sensing systems find particular application where only the final leg of a length of optical fibre is required to perform a sensing function. Consequently, where it is desirable to maximise the length of optical fibre used for sensing whilst maintaining a desired system dynamic range, these fibre optic sensing systems are unsuitable.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to a first aspect of embodiments of the present disclosure, there is provided an optical sensor apparatus comprising a length of optical fibre capable of supporting forward direction propagation and reverse direction propagation. The optical fibre supports propagation of electromagnetic radiation, which may comprise optical radiation, pulsed signals, back scatter and/or the like. In embodiments of the present disclosure, the length of optical fibre is interrupted by a plurality of longitudinally spaced shunt devices disposed along the length of optical fibre and a plurality of return optical fibres respectively coupled to the plurality of shunt devices. In embodiments of the present disclosure, each of the shunt devices is propagation direction selective.

In embodiments of the present disclosure, optical sensor comprises a part of a heterodyne distributed vibration sensing (hDVS) system, where the optical sensor provides for use of long lengths of optical fibre while maintaining the dynamic range of the hDVS system.

Each of the shunt devices may be arranged to shunt optically to the respective return optical fibre in respect of the reverse direction propagation.

The each shunt device may be propagation direction selective in respect of the reverse direction propagation in favour of the forward direction propagation.

Each of the plurality of shunt devices may comprise: an upstream main path port; an downstream main path port; and a third shunt port; wherein the each shunt device may be arranged to permit forward direction propagation incident at the upstream main path port to pass therethrough to the downstream main path port, and to divert reverse direction propagation incident at the downstream main path port to the shunt port.

The upstream main path port may be relative to a signal launch port of the length of optical fibre at an end thereof. The downstream main path port may be relative to a signal launch port of the length of optical fibre at an end thereof.

A number of the plurality of shunt device may be optical circulators.

The longitudinal spacing between different shunt devices along the length of the optical fibre may be substantially inconsistent.

The length of optical fibre may comprise: a first optical fibre section having a first of the plurality of shunt devices coupled to a first end thereof and a second of the plurality of shunt devices coupled to a second end thereof; and a second optical fibre section having a first end thereof operably coupled to the second of the shunt devices.

A second end of the second optical fibre section may be operably coupled to a third of the plurality of shunt devices, and the length of optical fibre may comprise a third optical fibre section having a first end thereof operably coupled to the third of the plurality of shunt devices.

A number of the plurality of shunt devices may each be preceded on an upstream side thereof by a respective first optical amplifier.

A number of the plurality of return optical fibres may be respectively coupled to the number of the plurality of shunt devices via a respective second optical amplifier.

The apparatus may further comprise: a respective optical filter disposed in-line and between the respective first optical amplifier and the respective shunt device.

The apparatus may further comprise: a respective optical splicer operably coupled between the respective first optical amplifier and the respective optical filter.

The apparatus may further comprise: a respective optical connector operably coupled between the respective first optical amplifier and the respective optical filter.

The apparatus may further comprise: another optical splicer or connector operably coupled after the respective second optical amplifier.

The apparatus may further comprise: an optical isolator operably coupled in-line and upstream of the respective first optical amplifier.

The apparatus may further comprise: an optical circulator operably coupled in-line and upstream of the respective first optical amplifier.

According to a second aspect of embodiments of the present disclosure, there is provided a distributed optical fibre sensor comprising the optical sensor apparatus as set forth above in relation to the first aspect of embodiments of the present disclosure.

According to a third aspect of embodiments of the present disclosure, there is provided an optical sensor system comprising the apparatus as set forth above in relation to the first aspect of embodiments of the present disclosure, an optical source operably coupled to a first end of the length of optical fibre and a plurality of optical detectors respectively operably coupled to the plurality of return optical fibres.

The optical source may be arranged to generate, when in use, an optical pulse signal and the plurality of optical detectors may be respectively arranged to receive, when in use, backscattered electromagnetic energy.

The optical pulse signal may have a period that is greater than a two way travel time for an electromagnetic signal between a portion of the length of optical fibre between a pair of neighbouring shunt devices.

The system may further comprise a coherent optical time domain reflectometer operably coupled to the plurality of optical detectors.

According to a fourth aspect of embodiments of the present disclosure, there is provided a wellbore optical sensing system comprising the system as set forth above in relation to the third aspect of embodiments of the present disclosure.

According to a fifth aspect of embodiments of the present disclosure, there is provided a heterodyne distributed vibration sensing system comprising the system as set forth above in relation to the third aspect of embodiments of the present disclosure.

According to a sixth aspect of embodiments of the present disclosure, there is provided a distributed acoustic sensing system comprising the system as set forth above in relation to the third aspect of embodiments of the present disclosure.

According to a seventh aspect of embodiments of the present disclosure, there is provided a method of detecting a parameter of interest using a fibre optic sensor. The method comprises introducing a probe signal into a length of optical fibre capable of supporting forward direction propagation and reverse direction propagation of electromagnetic radiation. In embodiments of the present disclosure, backscattered electromagnetic radiation is shunted to a plurality of detectors via respective return optical fibres. The shunts are disposed at longitudinally spaced intervals along the length of optical fibre respectively. In embodiments of the present disclosure, a parameter associated with the phase of the backscattered electromagnetic radiation is measured.

It is thus possible to provide an optical sensor apparatus and a method of detecting a parameter that permits use of longer lengths of optical fibre for sensing purposes as compared with known optical sensors. This use of longer lengths of optical fibre nevertheless supports at least maintenance and sometimes an increase in the PFR, and therefore dynamic range, of an optical sensing system employing the optical sensor apparatus over known systems.

### BRIEF DESCRIPTION OF THE DRAWINGS

Embodiments of the present disclosure will now be described, by way of example only, with reference to the accompanying drawings. It is emphasized that, in accordance with the standard practice in the industry, various features are not drawn to scale. In fact, the dimensions of the various features may be arbitrarily increased or reduced for clarity of discussion.

FIG. 1 is a schematic diagram of a wellbore containing a fibre optic sensor, in accordance with embodiments of the present disclosure;

FIG. 2 is a schematic diagram of a heterodyne distributed vibration sensing system employing the fibre optic sensor of FIG. 3, in accordance with embodiments of the present disclosure;

FIG. 3 is a schematic diagram of the fibre optic sensor referred to in FIGS. 1 and 2 in greater detail;

FIG. 4 is a flow diagram of a method of interrogating an optical fibre sensor, in accordance with embodiments of the present disclosure;

FIG. 5 is a schematic diagram of an alternative sensing system employing the fibre optic sensor of FIG. 3, in accordance with embodiments of the present disclosure;

FIG. 6 is a schematic diagram of an amplification arrangement that can be used with the fibre optic sensor of FIG. 3, in accordance with embodiments of the present disclosure;

FIG. 7 is a schematic diagram of another amplification arrangement that can be used with the fibre optic sensor of FIG. 3, in accordance with embodiments of the present disclosure;

FIG. 8 is a schematic diagram of a modification to the amplification arrangement of FIG. 4, in accordance with embodiments of the present disclosure; and

FIG. 9 is a schematic diagram of a marine streamer employing the fibre optic sensor of FIG. 3, in accordance with embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In some embodiments, the apparatus, systems and techniques described herein may be employed in conjunction with an intelligent completion system disposed within a well that penetrates a hydrocarbon-bearing earth formation. Portions of the intelligent completion system may be disposed within cased portions of the well, while other portions of the system may be in the uncased, or open hole, portion of the well. The intelligent completion system may comprise one or more of various components or subsystems, which include without limitation: casing, tubing, control lines (electric, fibre optic, or hydraulic), packers (mechanical, sell or chemical), flow control valves, sensors, in flow control devices, hole liners, safety valves, plugs or inline valves, inductive couplers, electric wet connects, hydraulic wet connects, wireless telemetry hubs and modules, and downhole power generating systems. Portions of the systems that are disposed within the well may communicate with systems or sub-systems that are located at the surface. The surface systems or sub-systems in turn may communicate with other surface systems, such as systems that are at locations remote from the well.

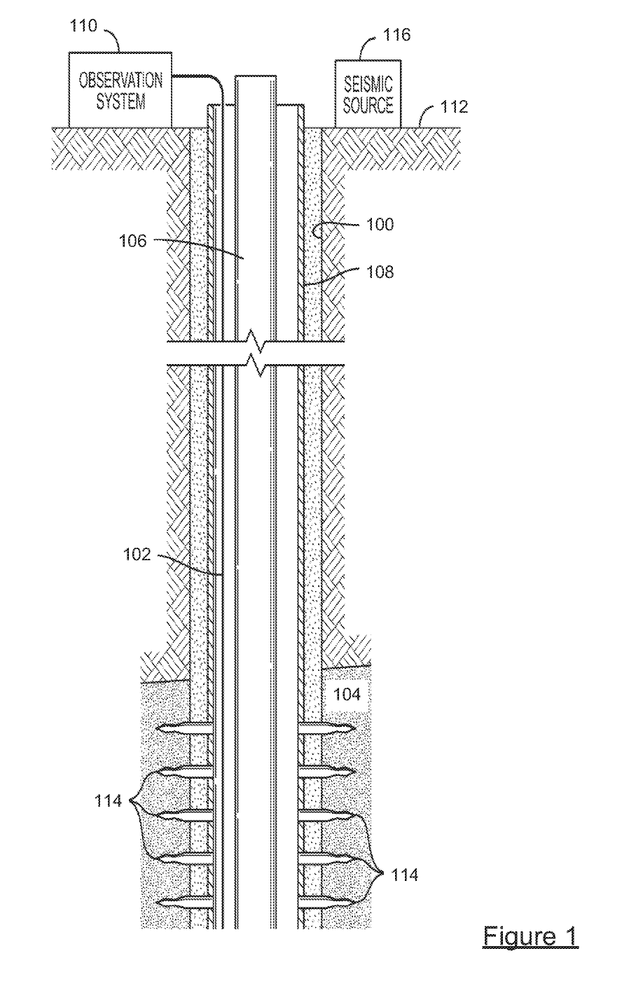

Referring to FIG. 1, a fibre optic cable, such as sensing fibre 102, may be deployed in a wellbore 100 to observe physical parameters associated with a region of interest 104 in a geological formation. In some embodiments, the sensing fibre 102 may be deployed through a control line and may be positioned in an annulus between a production tubing 106 and a casing 108. An observation system 110, which includes the interrogation, detection and acquisitions systems for a coherent phase-detection Optical Time Domain Reflectometry (OTDR) system described later herein, may be located at a surface 112 and coupled to the sensing fibre 102 to transmit probe pulses, detect returned backscatter signals, and acquire phase information to determine the parameters of interest, for example strain or vibration parameters, in the manners described later herein.

In order to reach the region of interest 104, the wellbore 100 is drilled through the surface 112 and the casing 108 is lowered into the wellbore 100. Perforations 114 are created through the casing 108 to establish fluid communication between the wellbore 100 and the formation in the region of interest 104. The production tubing 106 is then installed and set into place such that production of fluids through the tubing 106 can be established. Although a cased well structure is shown, it should be understood that embodiments of the present disclosure are not limited to this illustrative example. Uncased, open hole, gravel packed, deviated, horizontal, multi-lateral, deep sea or terrestrial surface injection and/or production wells (among others) may incorporate the phase coherent-detection OTDR system.

The fibre optic sensor 102 for the OTDR system may be permanently installed in the well or can be removably deployed in the wellbore 100, such as for use during remedial operations. In many applications, strain and pressure measurements obtained from the region of interest 104 using a phase coherent-detection OTDR system may provide useful information that may be used to increase productivity. For instance, the measurements may provide an indication of the characteristics of a production fluid, such as flow velocity and fluid composition. This information then can be used to implement various types of actions, such as preventing production from water-producing zones, slowing the flow rate to prevent coning, and controlling the injection profile, so that more oil is produced as opposed to water. The strain and pressure measurements also can provide information regarding the properties of the surrounding formation so that the phase coherent-detection OTDR system can be used for seismic surveying applications.

In this respect, a phase coherent-detection OTDR system can provide substantial advantages for seismic exploration and seismic production monitoring applications. For instance, seismic surveying applications, and particularly downhole seismic monitoring applications, employ seismic sources, for example a seismic source 116, to generate seismic signals for detection by an acoustic sensor, such as the fibre optic sensor 102, which may be configured to respond to acoustic forces incident along its length and which may be deployed downhole, for example in the wellbore 100.

Two different types of seismic sources are generally employed: impulsive sources, for example air guns or explosives, which may be either deployed at the surface 112 or downhole in the wellbore, and vibroseis sources. A vibroseis source is generally implemented by one or more trucks or vehicles that move across the surface and, when stationary, shake the ground in accordance with a controlled time/frequency function, which typically is a linearly varying frequency or “chirp.” When impulsive sources are used, optical signals captured by the fibre optic sensor 102 during seismic monitoring can be easily cross-correlated with the original acoustic signal incident upon the fibre optic sensor 102, since the firing of the impulsive source is a discrete event.

However, for vibroseis sources, the captured signals must be linearly related to the acoustic signals incident upon the fibre optic sensor 102 in order to perform the cross-correlation between the captured signals and the original chirp signal. The COTDR systems described above can be used to measure strain through the estimation of the phase of backscattered light. Yet further, because of the relationship between the acoustic signals that impart a strain on the sensor and the resulting optical signal, beam-forming methods can be employed to filter the incoming acoustic waves by angle, thus providing for more precise characterization of the properties of the surrounding geologic formation.

Embodiments of the phase coherent-detection OTDR systems set forth herein above can also be employed in applications other than hydrocarbon production and seismic or geologic surveying and monitoring. For instance, embodiments of the phase coherent-detection OTDR systems can be implemented in intrusion detection applications or other types of applications where it may be desirable to detect disturbances to a fibre optic cable. As another example, embodiments of the phase coherent-detection OTDR systems can be employed in applications where the fibre optic sensor is deployed proximate an elongate structure, such as a pipeline, to monitor and/or detect disturbances to or leakages from the structure. In another embodiment, as will be described later herein, the fibre optic sensor can be used in conjunction with a marine streamer.

The embodiments mentioned above employ coherent-detection OTDR techniques (generally, launching a narrow-band optical pulse into an optical fibre and mixing the Rayleigh backscattered light with a portion of the continuous light coming directly from the optical source) combined with phase measurements to measure a parameter of interest in the region in which the optical fibre is deployed. In some embodiments, the measured phases may be differentiated over a selected differentiation interval and the time variation of these differentiated phase signals may be a measure of the parameter of interest. In various other embodiments, multiple interrogation frequencies may be used to enhance the linearity of the measurement and to reduce the fading that otherwise may be present in a coherent-detection OTDR system that employs a single interrogation frequency.

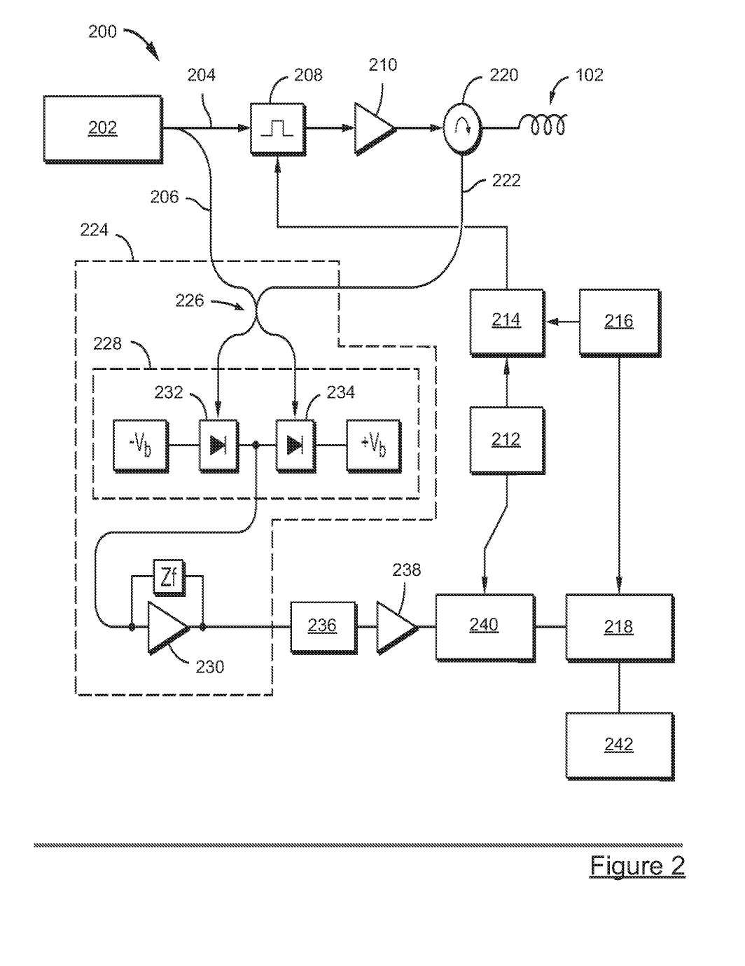

Turning to FIG. 2, in an exemplary arrangement of a phase-measuring OTDR system 200 that employs heterodyne coherent detection, the system 200 includes an optical source 202, which can be a narrowband source such as a distributed feedback fibre laser, which generally provides the narrowest available spectrum of lasers for which the emission wavelength can be selected over a wide range. The output of the source 202 is divided into a local oscillator path 206 and another path 204. In path 204, a modulator 208 modulates an optical signal into a probe pulse, which additionally may be amplified by an amplifier 210 prior to being launched into a sensing fibre 102. In this example, the probe pulse and the local oscillator signal are at different carrier frequencies.

A frequency shift is introduced in the probe pulse, which may be achieved, for instance, by selecting the modulator 208 to be of the acousto-optic type, where the pulsed output is taken from the first diffraction order, or higher. All orders other than zero of the output of such devices are frequency-shifted (up or down) with respect to the input light by an amount equal to (for first order) or integer multiple of (for second order or higher) the radio-frequency electrical input applied to them. Thus, in this example, an Intermediate Frequency (IF) source 212, for example a radio frequency oscillator, provides a driving signal for the modulator 208, gated by an IF gate 214 under the control of a trigger pulse 216. The optical pulse thus emitted by the modulator 208 is frequency-shifted relative to the light input to the modulator 208 from the optical source 202, and therefore also relative to the local oscillator signal in the path 206.

The trigger 216 synchronizes, in this example, the generation of the probe pulse with an acquisition by the system 200 of samples of the backscatter signal generated by the sensing fibre 102, from which the phase (and indeed the amplitude) information may be calculated. In various embodiments, the trigger 216 can be implemented as a counter within an acquisition system 218 that determines the time at which the next pulse should be generated by the modulator 208. At the determined time, the trigger 216 causes the IF gate 214 to open simultaneously with initiating acquisition by the acquisition system 218 of a pre-determined number of samples of the phase information. In other embodiments, the trigger 216 can be implemented as a separate element that triggers initiation of the probe pulse and acquisition of the samples in a time-linked manner. For instance, the trigger 216 can be implemented as an arbitrary waveform generator that has its clock locked to the clock of the acquisition system 218 and which generates a short burst at the IF rather than the arrangement shown of an IF source 114 followed by a gate 214.

In other arrangements, the frequency difference between the probe pulse launched into the sensing fibre 102 and the local oscillator signal in the path 206 may be implemented in manners other than by using the modulator 208 to shift the frequency of the probe pulse. For instance, a frequency shift may be achieved by using a non-frequency-shifting modulator in the probe pulse path 204 and then frequency-shifting (up or down) the light prior to or after the modulator 208. Alternatively, the frequency shifting may be implemented in the local oscillator path 206.

The system 200 also comprises a first circulator 220 that passes the probe pulse into the sensing fibre 102 and diverts returned light to a first return optical fibre 222, where it is directed to a coherent-detection system 224 that generates a mixed output signal. In an exemplary implementation, the coherent-detection system 224 includes a directional coupler 226, a detector 228 and a receiver 230. The directional coupler 226 combines the returned light in the first return optical fibre 222 with the local oscillator light in the path 206. The output of the coupler 226 is directed to the detector 228. In this example, the detector 228 is implemented as a pair of photodetectors 232, 234, for example photodiodes, which are arranged in a balanced configuration. The use of a photodetector pair 232, 234 can be particularly useful, because it makes better use of the available light and can cancel the light common to both outputs of the coupler 226 and, in particular, common-mode noise. The detector 228, or photodetector pair 232, 234, provide(s) a current output centred at the IF that is passed to the receiver 230, for example a current input preamplifier or a transimpedance amplifier, which provides the mixed output signal, for example the IF signal.

A filter 236 is operably coupled to an output of the receiver 230 and can be used to select a band of frequencies around the IF and the filtered signal can then be amplified by an amplifier 238 and sent to a phase-detection circuit 240 that detects the phase of the mixed output signal, for example the IF signal, generated by the coherent-detection system 224 relative to an external reference, for example the IF source 212. The phase-detection circuit 240 for extracting the phase of the mixed output signal can be implemented by a variety of commercially available devices, such as the AD8302 RF/IF gain phase detector, available from Analog Devices, Inc. (of Norwood, Mass., USA).

In this example, the IF source 212, which generates the driving signal used to shift the relative frequencies of the local oscillator and the backscatter signals by a known amount and which is related to the frequency of the driving signal, is also fed to the phase-detection circuit 240 to provide a reference. Thus, the phase-detector 240 provides an output that is proportional (modulo 360°) to the phase-difference between the backscatter signal (mixed down to IF) and the reference from the IF source 212. The output of the phase detection circuit 240 is provided to the acquisition system 218 that is configured to sample the incoming signal to acquire the phase information therefrom. As mentioned above, the trigger 216 time synchronizes the sampling of the incoming signal with the generation of the probe pulse.

The acquisition system 218 may include a suitable processor, for example a general purpose processor or microcontroller, and associated memory device(s) for performing processing functions, such as normalization of the acquired data, data averaging, storage in a data storage unit 242, and/or display to a user or operator of the system. In some embodiments, the acquisition system 218 may include an analogue-to-digital converter to digitize the received signal and the amplitude information can then be acquired from the digital data stream.

In general, the technique for detecting phase in the backscatter signal, such as for measuring changes in local strain along the length of the sensing fibre 102, can be summarized as follows. The optical output of a highly-coherent optical source, for example the source 202, is divided between two paths, for example the paths 204 and 206. Optionally, the carrier frequency of the signal in one or both of the paths may be frequency shifted to ensure that the carrier frequencies of the optical signals in the two paths differ by a known amount.

Regardless of whether frequency-shifting is employed, the signal in the first path 204 is modulated to form a pulse, which optionally may be amplified. The pulse is then launched into the sensing fibre 102, which generates a backscatter signal in response to the pulse. The backscatter signal return is separated from the forward-traveling light and then mixed with the light in the second path 206 onto at least one photodetector to form a mixed output signal, such as an intermediate frequency (IF) signal. In embodiments in which there is no frequency shift, this IF is at zero frequency. Based on a known speed of light in the sensing fibre 102, the phase of the IF at selected locations along the fibre can be extracted and measured. The difference in phase between locations separated by at least one pre-defined distance interval along the sensing fibre 102 can be calculated.

As an example, the phase may be measured at locations every meter along the sensing fibre 102 and the phase difference may be determined between locations separated by a ten meter interval, such as between all possible pairs of locations separated by ten meters, a subset of all possible pairs of locations separated by ten meters, etc. Finally, at least one more optical pulse is launched into the sensing fibre, phase information at locations along the fibre is extracted from the resultant mixed output signal (created by mixing the backscatter signal with the light in the second path), and the phase differences between locations are determined. A comparison is then performed of the phase differences as a function of distance (obtained based on the known speed of light) along the sensing fibre 102 for at least two such probe pulses. The results of this comparison can provide an indication and a quantitative measurement of changes in strain at known locations along the sensing fibre 102.

Although the foregoing discussion has described the cause of changes in the phase-difference of the backscatter signal as being strain incident on the optical fibre 102, other parameters, such as temperature changes, also have the ability to affect the differential phase between sections of the sensing fibre 102. With respect to temperature, the effect of temperature on the sensing fibre 102 is generally slow and can be eliminated from the measurements, if desired, by high-pass filtering the processed signals. Furthermore, the strain on the sensing fibre 102 can result from other external effects than those discussed above. For instance, an isostatic pressure change within the sensing fibre 102 can result in strain on the sensing fibre 102, such as by pressure-to-strain conversion by the coating of the sensing fibre 102.

Regardless of the source of the change in phase differentials, phase detection may be implemented in a variety of manners. In some embodiments, the phase detection may be carried out using analogue signal processing techniques or by digitizing the IF signal and extracting the phase from the digitized signal.

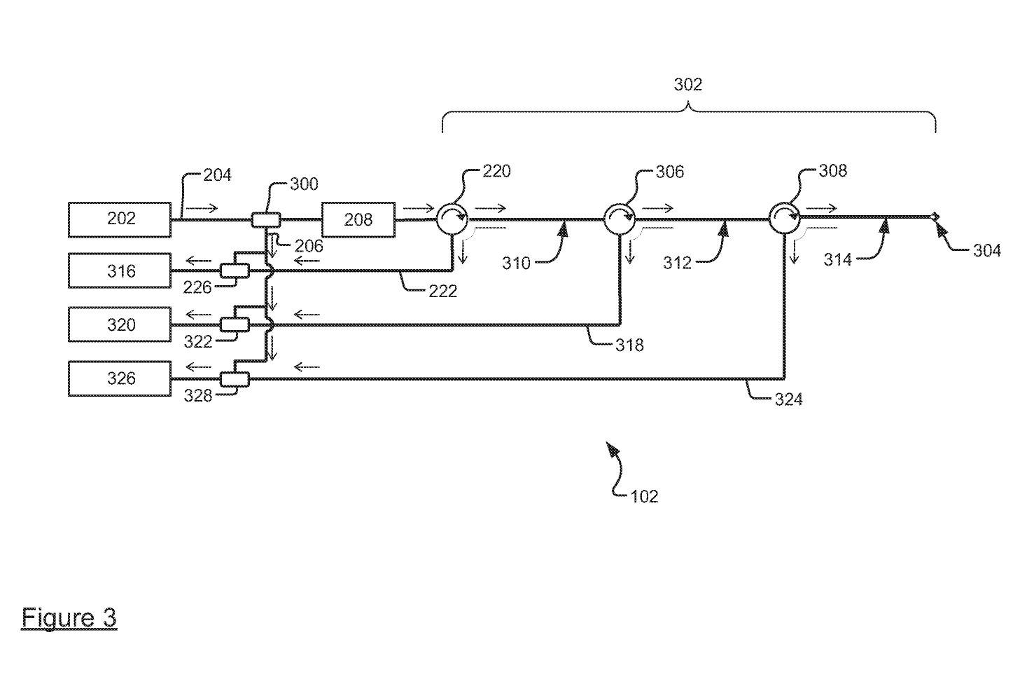

Although not shown, the coherent detection system 224, the filter 236, the amplifier 238, the phase detector 240 and the acquisition system 218 are replicated in order to support the configuration of the optical fibre sensor 102 of FIG. 3, and will be referred hereinafter as detection units. In this respect, and referring to FIG. 3, the optical fibre sensor 102 is operably coupled to the narrowband source 202 via a first splitter 300 (not shown in FIG. 2) to create the local oscillator path 206, the modulator 208 and the first circulator 220 to create the first return path 222.

The optical fibre sensor 102 comprises a length of optical fibre 302 that is capable of supporting forward direction propagation, for example propagation of light from the source 202 to a distal end 304 of the length of optical fibre 302, and reverse direction propagation, for example propagation of light in a direction opposite to the forward direction propagation. The length of optical fibre is interrupted by a plurality of longitudinally spaced circulators constituting shunt devices, for example the first circulator 220, a second circulator 306 and a third circulator 308 disposed along the length of optical fibre 302.

The length of optical fibre 302 is therefore divided into a first section of optical fibre 310, a second section of optical fibre 312 and a third section of optical fibre 314. The first section of optical fibre 310 has a first end thereof operably coupled to the first circulator 220 and a second end thereof operably coupled to the second circulator 306. The second section of optical fibre 312 has a first end thereof operably coupled to the second circulator 306 a second end thereof operably coupled to the third circulator 308. The third section of optical fibre 314 has a first end thereof operably coupled to the third circulator 308 and a second end thereof that constitutes the distal end 304 of the length of optical fibre 302.

As described above, the first return optical fibre 222 is also operably coupled to a first detection unit 316 via the first directional coupler 226. A second return fibre 318 is operably coupled at a first end thereof to the second circulator 306 and at a second end thereof to a second detection unit 320 via a second directional coupler 322, the second directional coupler also being operably coupled to the local oscillator path 206. A third return optical fibre 324 has a first end thereof operably coupled to the third circulator 308, a second end of the third return optical fibre 324 being operably coupled to a third detection unit 326 via a third directional coupler 328 that is also operably coupled to the local oscillator path 206. Hence, it can be seen that a plurality of return optical fibres, which are respectively coupled to the plurality of shunt devices, are employed.

Furthermore, in this example, given a PRF of 10 kHz the length of optical fibre 302 is divided into lengths of 10 km, although other lengths of optical fibre may be employed, depending upon application requirements. In this respect, the length of the section of optical fibre employed depends upon the choice of PRF, because sufficient time needs to be allowed to enable an optical pulse signal to propagate along the section of optical fibre and then for a backscattered signal to return to the beginning of the section of optical fibre from where the backscattered signal is shunted. Indeed, one or more of the plurality of lengths of optical fibre can be different with respect to each other, thereby making the lengths of the sections of optical fibre inconsistent with respect to each other.

In some embodiments of the present disclosure, the systems illustrated in FIGS. 1 & 2 may comprise hDVS systems. In such embodiments, the optical sensor of FIG. 3 may provide for the use of long lengths of optical fibre, while maintaining the dynamic range of the hDVS system.

In an hDVS sensing system, dynamic range is an important system parameter that requires the frequency of the pulses of light injected into the optical fibre, the PRF, to be supportive of the desired system dynamic range. However, as a result of the PRF used, a limitation is imposed on the maximum length of the optical fibre that can be interrogated: as the PRF increases, the maximum length of the optical fibre decreases, because any pulse launched into the optical fibre must not propagate along the optical fibre while backscattered light attributable to a preceding pulse is propagating along the optical fibre. For some applications, this constraint might be disadvantageous.

Consequently, in some embodiments of the present disclosure, the optical sensor of FIG. 3, is used to provide an hDVS system that can use a long length of the optical fibre 310 by returning the pulses for hDVS processing through the shunts. This may provide for an hDVS system for wellbore and/or pipeline monitoring. In another example, the optical fibre sensor of FIG. 3 may be used in a marine seismic hDVS system, where the sensor of FIG. 3 is comprises the optical fibre 310 wrapped to form coils that are deployed along a seismic streamer for seismic surveying/measuring seismic data.

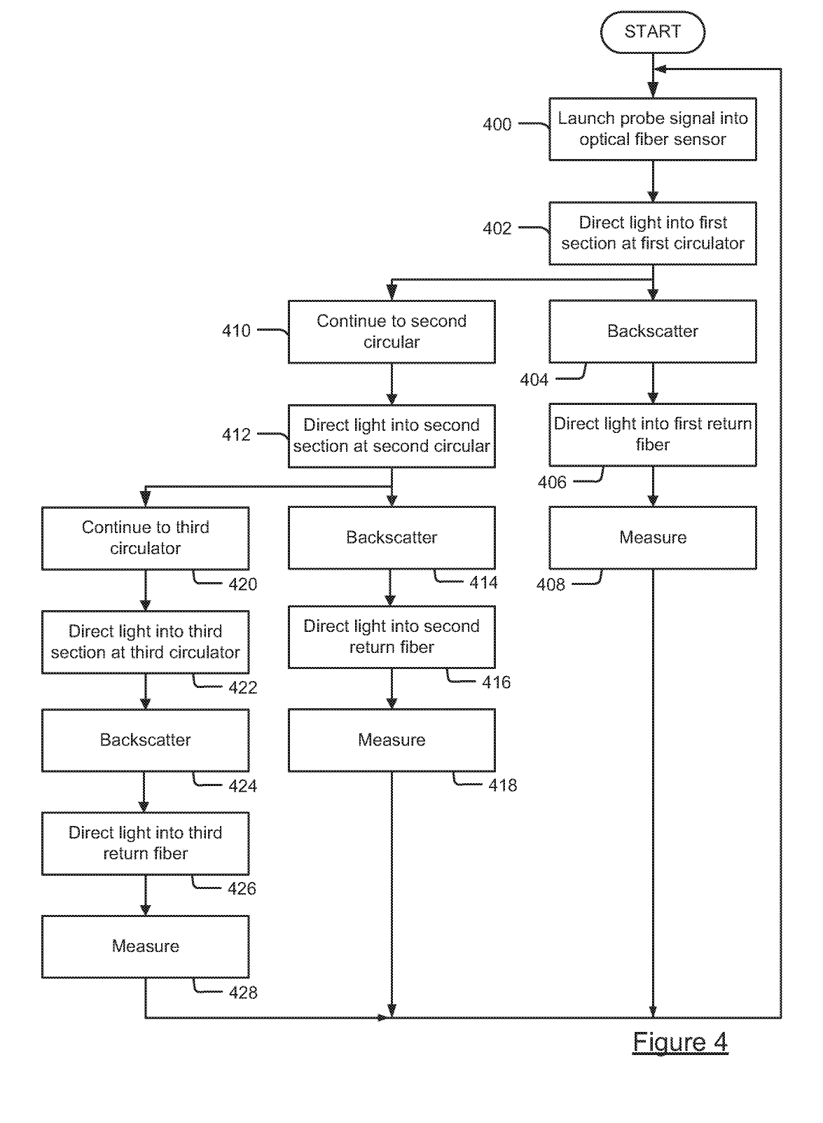

In operation (FIG. 4), the light source 202 launches an optical probe signal, for example a pulse as described above, into the path 204, which is split so that the light also propagates along the local oscillator path 206. The light propagating along the path 204 is modulated by the modulator 208 and the modulated light is launched (Step 400) into the length of optical fibre 302 via the first circulator 220. The first circulator 220 is directionally selective and so directs (Step 402) light incident at an upstream main path port thereof from the modulator 208 to a downstream main path port thereof and hence into the first section of optical fibre 310. The probe light propagating along the first section of optical fibre 310 undergoes backscattering (Step 404) and so the proportion of the probe signal that is backscattered propagates back along the first section of optical fibre 310 towards the first circulator 220. As the first circulator 220 is directionally selective, instead of directing light incident at the downstream main path port to the upstream main path port, the first circulator 220 directs (Step 406) the backscattered light to a shunt port thereof and hence the backscattered light is launched into the first return optical fibre 222 as already described above in relation to FIG. 2. Thereafter, measurements (Step 408) are made in relation to the optical signal received at the first detection unit 316.

Not all of the optical power of the probe signal is backscattered and so the probe signal propagating along the first section of optical fibre 310 is also incident (Step 410) at the upstream main path port of the second circulator 306. Similar to the first circulator 220, the second circulator 306 directs (Step 412) forward direction propagation to the downstream main path port thereof and so the probe signal is launched into the second section of optical fibre 312, the probe signal propagating along the second section of optical fibre 312. The probe light propagating along the second section of optical fibre 312 also undergoes backscattering (Step 414) and so the proportion of the probe signal that is backscattered propagates back along the second section of optical fibre 312 towards the second circulator 306. As the second circulator 306 is directionally selective, instead of directing light incident at the downstream main path port to the upstream main path port, the second circulator 306 directs (Step 416) the backscattered light to the shunt port thereof and hence the backscattered light is launched into the second return optical fibre 318 and so propagates to the second detection unit 320. Thereafter, measurements (Step 418) are made in relation to the optical signal received at the second detection unit 320.

Again, as not all of the optical power of the probe signal is backscattered in the second section of optical fibre 312, the probe signal propagating along the second section of optical fibre 312 is also incident (Step 420) at the upstream main path port of the third circulator 308. Similar to the second circulator 306, the third circulator 308 directs (Step 422) forward direction propagation to the downstream main path thereof and so the probe signal is launched into the third section of optical fibre 314, the probe signal then propagating along the third section of optical fibre 314. The probe light propagating along the third section of optical fibre 314 undergoes backscattering (Step 424) and so the proportion of the probe signal that is backscattered propagates back along the third section of optical fibre 314 towards the third circulator 308. As the third circulator 308 is also directionally selective, instead of directing light incident at the downstream main path port to the upstream main path port, the third circulator 308 directs (Step 428) the backscattered light to the shunt port thereof and hence the backscattered light is launched into the third return optical fibre 324 and so propagates to the third detection unit 326. Thereafter, measurements (Step 428) are made in relation to the optical signal received at the third detection unit 326.

In order to avoid a subsequent probe signal propagating in any of the first, second or third sections of optical fibre 310, 312, 314 before the backscattered light has been shunted by the first, second and third circulators 220, 306, 308 to the first, second and third return optical fibres 222, 318, 324, respectively, the frequency of the pulsed probe signal is set to support safe return of the backscattered optical signal to the circulators (and shunting of the backscattered light). In accordance with the frequency employed, a subsequent optical probe signal is generated and launched into the optical fibre sensor 102 and the above steps (Steps 400 to 428) are repeated.

Although the above example has been described in the context of a heterodyne coherent OTDR measurement technique, the skilled person should appreciate that the optical fibre sensor 102, with any suitable adaptation necessary, can be employed in relation to other measurement techniques. Indeed, the principle of shunting backscattered light in a section-wise manner instead of forcing the backscattered light to propagate all or most of the way back to a proximal, for example launch, end of the optical fibre sensor 102 can be widely deployed in order to extend the length of optical fibre sensor that can be employed with various measurement techniques.

In this respect, and referring to FIG. 5, the light source 202 is operably coupled to the modulator 208, the modulator 208 being operably coupled to the first circulator 220 of the optical fibre sensor 102 via a length of input optical fibre 500. As described in FIG. 3, the optical fibre sensor 102 has the first circulator 220, the second circulator 306 and the third circulator 308, the first and second circulators 220, 306 being joined via the first section of optical fibre 310, the second and third circulators 306, 308 being joined by the second section of optical fibre 312; the third circulator 308 is operably coupled to one end of the third section of optical fibre 314. As in the case of the fibre optic sensor 102 of FIG. 3, the first, second and third return optical fibres 222, 318, 324 are respectively coupled to a first alternative detection unit 502, a second alternative detection unit 504 and a third alternative detection unit 506.

The first alternative detection unit 502 comprises optical receiver 508.

In operation, the source 202, in conjunction with the modulator 208, generates a first pulse signal 520 and a second pulse signal 522 arranged so as to possess the predetermined separation distance described above. Additionally, the first pulse signal 500 is arranged so as to have a first frequency shift associated therewith and the second pulse signal 502 is arranged so as to have a second frequency shift associated therewith.

The first and second pulse signals 520, 522 constitute a probe signal that is applied to the fibre optic sensor 102 via the input optical fibre 500. In this respect, the behaviour of the fibre optic sensor 102 in relation to stimulation by the probe signal does not differ to the behaviour of the fibre optic sensor 102 in relation to other applications of the fibre optic sensor 102 described above and so a description of the propagation of optical signals through the fibre optic sensor 102 will not be repeated, save to acknowledge that the first, second and third circulators 220, 306, 308 in conjunction with the first, second and third return optical fibres 222, 318, 324 shunt backscattered light derived from the probe signal to the first, second and third alternative detection units 502, 504, 506, respectively.

In contrast to the other examples employing the optical fibre sensor 102 described above, the first, second and third alternative detection units 502, 504, 506 respond to the backscattered light received via the first, second and third return optical fibres 222, 318, 324, respectively, in a different manner. In this respect, the second and third alternative detection units 504, 506 operate in a like manner to the first alternative detection unit 502 and so, for the sake of conciseness of description, operation of the first alternative detection unit 502 will only be described herein.

Backscattered light generated in the first section of optical fibre 310 of the fibre optic sensor 102 in response to the first and second pulse signals 520, 522 propagate back to the optical receiver 508. When the backscattered light from the first and second pulse signals 520, 522 is received by the optical receiver 508, the received backscattered signals form a beat signal that is subsequently analysed in order to determine a parameter of interest to be measured.

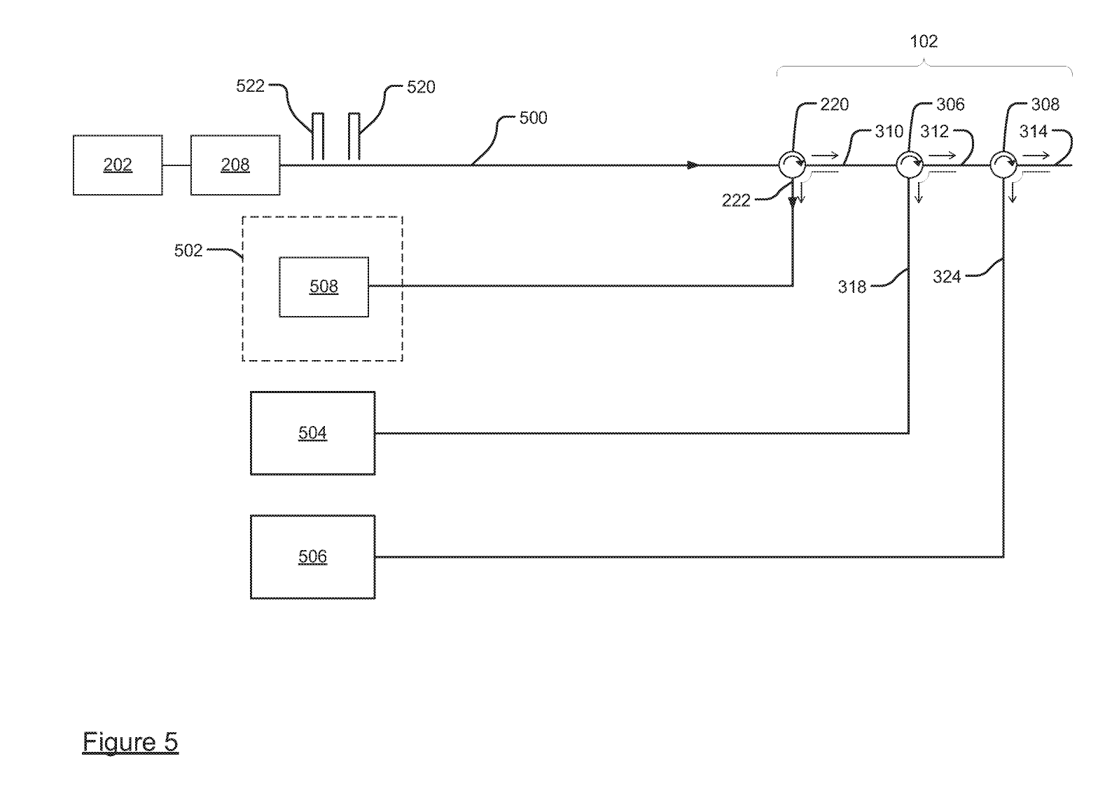

Turning to FIG. 6, in another embodiment, prior to one or more of the circulators 220, 306, 308, for example the third circulator 308, an amplifier 600 and an optical filter 602 can be provided. In this respect, an output of the optical filter 602 is operably coupled to the upstream main path port of the third circulator 308 and an input of the optical filter 602 is operably coupled to an output of the amplifier 600. In this example, the input of the amplifier 600 is operably coupled to the second section of optical fibre 312. The shunt port of the third circulator 308 is coupled to an input of another optical amplifier 604, and an output of the amplifier 604 is operably coupled to the third return optical fibre 324. The provision of the amplifiers 600, 604 and the filter 602 serve to improve optical signal dynamic range due to the attenuation with propagation distance of the probe signal launched into the optical fibre sensor 102.

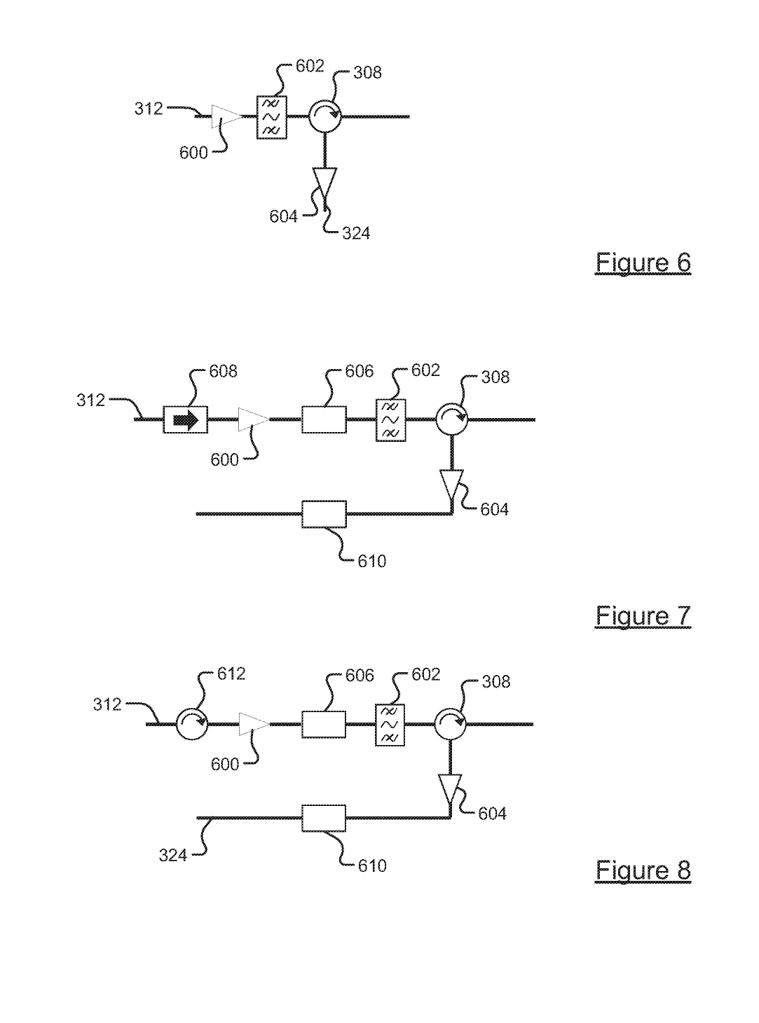

In an alternative configuration (FIG. 7), the output of the amplifier 600 can be coupled to the input of the filter 602 via a splicing or optical connector 606. However, in order to reject any reflected signals induced by the splicing or connector 606, an optical isolator 608 can be coupled in-line in a location preceding the amplifier 600. Another splicing or optical connector 610 can also be coupled between the third return optical fibre 324 and the output of the amplifier 604. This arrangement is particularly useful for applications where the fibre optic sensor 102 is in a streamer, for example a marine streamer, or is a long sensing cable where the entire cable is divided into sections that require separation.

In another example (FIG. 8), the optical isolator 608 of FIG. 7 can be replaced with an auxiliary circulator 612.

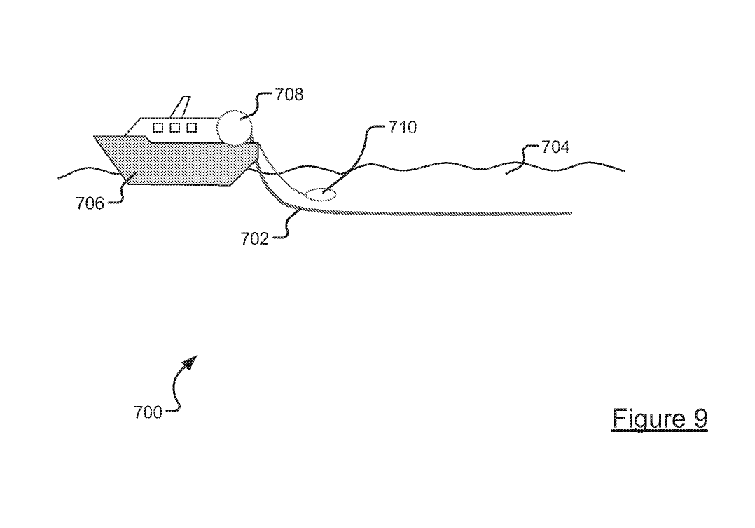

Turning to FIG. 9, in a marine environment 700, a streamer cable 702 can be towed through a body of water, for example the sea 704 by an appropriate sea-faring vessel 706 having a control system (not shown). The control system may include various processors and computing devices configured to communicate, for example electrically or wirelessly, with the seismic streamer cable and/or devices associated with the streamer cable, for example deflectors, steering devices, and/or sensors. The vessel 706 carries a reel or spool 708 for carrying the cable 702 when not deployed. A signal source 710, for example a seismic sources, such as air guns, marine vibrators and/or explosives, is towed by the vessel 706.

In this example, the cable can comprise the optical fibre sensor 102 as described in relation to any of the embodiments above. Furthermore, although not shown in the detail of FIG. 9, the optical fibre sensor 102 can be part of any appropriate type of sensing system for measuring a parameter of interest, for example as described above in relation to the different sensing techniques contemplated.

In operation, the signal source emits signals into the body of water 704, which propagate through the body of water 704 into subterranean structure (not shown). The signals may be reflected from layers in the subterranean structure, including a resistive body that can be any one of, for example, a hydrocarbon-containing reservoir, a fresh water aquifer, or an injection zone. Signals reflected from resistive body may propagate upwardly toward the cable 702 for detection by the optical fibre sensor 102 operating in conjunction with other parts of a sensing system. Measurement data may thus be collected for analysis.

It will be understood that the above disclosure provides many different embodiments, or examples, for implementing different features of various embodiments. Specific examples of components and arrangements are described above to simplify the present disclosure. These are, of course, merely examples and are not intended to be limiting. Indeed, variations to the above embodiments are contemplated. For example, although the above embodiments have been described in the context of active seismic surveying, the skilled person should appreciate that the apparatus and methods set forth herein can be employed in relation to passive seismic monitoring, for example microseismic activity detection, such as is sometimes employed in relation to hydraulic fracturing activities.

By way of further example, although optical circulators are employed in the examples set forth above, it is contemplated that other optical arrangements, which provide the shunting of optical signals in the manner described herein, can be employed.

It should be appreciated that references herein to “light”, other than where expressly stated otherwise, are intended as references relating to the optical range of the electromagnetic spectrum, for example, between about 350 nm and about 2000 nm, such as between about 550 nm and about 1400 nm or between about 600 nm and about 1000 nm.

In the above detailed description, embodiments are described in sufficient detail to enable those skilled in the art to practice the invention. It is to be understood that the various embodiments, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the spirit and scope of the invention. As mentioned above, the above detailed description is, therefore not to be taken in a limiting sense, and the scope of the present invention is defined only by the appended claims, appropriately interpreted, along with the full range of equivalents to which the claims are entitled.

It should also be noted that in the development of any such actual embodiment, numerous decisions specific to circumstance must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

1. An optical sensor apparatus comprising:
a length of optical fibre capable of supporting forward direction propagation and reverse direction propagation, the length of optical fibre being interrupted by a plurality of longitudinally spaced shunt devices disposed along the length of optical fibre; and
a plurality of return optical fibres respectively coupled to the plurality of shunt devices; wherein each of the shunt devices is propagation direction selective.

2. An apparatus as claimed in claim 1, wherein each of the shunt devices is arranged to shunt optically to the respective return optical fibre in respect of the reverse direction propagation.

3. An apparatus as claimed in claim 1 or claim 2, wherein the each shunt device is propagation direction selective in respect of the reverse direction propagation in favour of the forward direction propagation.

4. An apparatus as claimed in any one of the preceding claims, wherein:
each of the plurality of shunt devices comprises:
an upstream main path port;
an downstream main path port; and
a third shunt port; and
the each shunt device is arranged to permit forward direction propagation incident at the upstream main path port to pass therethrough to the downstream main path port, and to divert reverse direction propagation incident at the downstream main path port to the shunt port.

5. An apparatus as claimed in any one of the preceding claims, wherein a number of the plurality of shunt device comprise optical circulators.

6. An apparatus as claimed in any one of the preceding claims, wherein the longitudinal spacing between different shunt devices along the length of the optical fibre is substantially inconsistent.

7. An apparatus as claimed in any one of the preceding claims, wherein the length of optical fibre comprises:
a first optical fibre section having a first of the plurality of shunt devices coupled to a first end thereof and a second of the plurality of shunt devices coupled to a second end thereof; and
a second optical fibre section having a first end thereof operably coupled to the second of the shunt devices.

8. An apparatus as claimed in any one of the preceding claims, wherein a number of the plurality of shunt devices is each preceded on an upstream side thereof by a respective first optical amplifier.

9. An apparatus as claimed in claim 8, wherein a number of the plurality of return optical fibres is respectively coupled to the number of the plurality of shunt devices via a respective second optical amplifier.

10. An apparatus as claimed in claim 8, further comprising:
a respective optical filter disposed in-line and between the respective first optical amplifier and the respective shunt device.

11. An apparatus as claimed in claim 10, further comprising:
a respective optical splicer operably coupled between the respective first optical amplifier and the respective optical filter.

12. An apparatus as claimed in claim 10, further comprising:
a respective optical connector operably coupled between the respective first optical amplifier and the respective optical filter.

13. An apparatus as claimed in claim 9, further comprising:
another optical splicer or connector operably coupled after the respective second optical amplifier.

14. An apparatus as claimed in claim 11, further comprising:
an optical isolator operably coupled in-line and upstream of the respective first optical amplifier.

15. An apparatus as claimed in claim 11, further comprising:
an optical circulator operably coupled in-line and upstream of the respective first optical amplifier.

16. A distributed optical fibre sensor comprising the optical sensor apparatus as claimed in any one of the preceding claims.

17. An optical sensor system comprising:
the apparatus as claimed in any one of claims 1 to 15;
an optical source operably coupled to a first end of the length of optical fibre; and
a plurality of optical detectors respectively operably coupled to the plurality of return optical fibres.

18. A system as claimed in claim 17, wherein the optical source is arranged to generate, when in use, an optical pulse signal and the plurality of optical detectors are respectively arranged to receive, when in use, backscattered electromagnetic energy.

19. A system as claimed in claim 18, wherein the optical pulse signal has a period that is greater than a two way travel time for an electromagnetic signal between a portion of the length of optical fibre between a pair of neighbouring shunt devices.

20. A system as claimed in claim 17, further comprising a coherent optical time domain reflectometer operably coupled to the plurality of optical detectors.

21. A wellbore optical sensing system comprising the system as claimed in any one of claims 17 to 20.

22. A heterodyne distributed vibration sensing system comprising the system as claimed in any one of claims 17 to 20.

23. A distributed acoustic sensing system comprising the system as claimed in any one of claims 17 to 20.

24. A method of detecting a parameter of interest using a fibre optic sensor, the method comprising:
introducing a probe signal into a length of optical fibre capable of supporting forward direction propagation and reverse direction propagation;
at longitudinally spaced intervals along the length of optical fibre, shunting backscattered electromagnetic radiation to a plurality of detectors via respective return optical fibres; and
measuring a parameter associated with the phase of the backscattered electromagnetic radiation.

25. The method of claim 24, further comprising:
using the measured parameter to process heterodyne distributed vibration data from the optical fibre.
